(19) United States
(12) Patent Application Publication
(10) Pub. No.: US 2001/0021164 A1
(43) Pub. Date: Sep. 13, 2001

(54) Objective lens driving apparatus

(75) Inventors: Hitoshi Fujii, Osaka (JP); Hiroshi Yamamoto, Kyoto (JP)

Correspondence Address: MERCHANT & GOULD PC, P.O. BOX 2903, MINNEAPOLIS, MN, 55402-0903, US

(73) Assignee: Matsushita Electric Industrial Co., Ltd.

(21) Appl. No.: 09/779,091

(22) Filed: Feb. 8, 2001

(30) Foreign Application Priority Data
Mar. 13, 2000 (JP) 2000-068308

(51) Int. Cl. G11B 21/02; G11B 7/08

(52) U.S. Cl. 369/215; 369/44.15

(57) ABSTRACT

An objective lens driving apparatus, in which driving coil blocks 10a, 10b are placed on a stationary base 5 so as to be symmetrical with respect to an objective lens 1 in the direction of a disk radius r. Magnets 3a to 3d are placed on a movable body 4 so as to be on both sides of each of the driving coil blocks 10a, 10b in the direction of a tangent t to a recording track of a disk. Since both sides of the driving coil blocks 10a, 10b can be used for the driving in the focusing, tracking, and radial-tilt directions, the effective part of the coil is doubled, and thus the driving sensitivity can be improved significantly.

### BACKGROUND OF THE INVENTION

1. Field of the Invention

The present invention relates to an objective lens driving apparatus in an optical head used for an optical recording/reproducing apparatus or the like. In particular, the present invention relates to a three-axis objective lens actuator having the function of correcting the inclination of an optical axis with respect to a disk.

2. Description of the Related Art

Recent advances in the development of techniques for an information recording/reproducing apparatus of high density, high speed, small thickness, and low cost have been remarkable. Many studies have been conducted on a so-called optical disk recording/reproducing apparatus for optically recording or reproducing information on a disk-shaped recording medium.

In an optical disk recording/reproducing apparatus, a tilt, which is the inclination of the optical axis of an objective lens with respect to a disk surface, causes an optical aberration that leads to the degradation of signals during recording and reproduction. To deal with this problem, it is necessary to correct not only focusing errors caused by the up-and-down vibration of a disk surface and tracking errors caused by the eccentricity of recording tracks but also the inclination of the optical axis of an objective lens with respect to a disk surface. Thus, an objective lens driving apparatus for driving an objective lens in three axes, i.e., a focusing direction, a tracking direction, and a direction of rotation around an axis parallel to a tangent to a recording track of a disk (hereinafter, referred to as a “radial-tilt direction”) has been proposed recently.

This type of conventional objective lens driving apparatus is disclosed in, e.g., JP 9-022537 A. FIG. 4 shows a schematic plan view of the conventional objective lens driving apparatus, describing its configuration and operation.

Referring to FIG. 4, a movable body 4 includes an objective lens 1, a lens holder 2 for holding the objective lens 1, and two magnets 3a, 3b fixed to the lens holder 2. The direction of magnetization of the magnets 3a, 3b corresponds to the direction of a tangent t to a recording track of a disk, and the two magnets are placed symmetrically with respect to the objective lens 1 in the tangent t direction. The movable body 4 is held by a stationary base 5 via four metallic wires 6a to 6d that are parallel to each other with one end fixed to the movable body 4 and the other end fixed to the stationary base 5. In FIG. 4, the metallic wires 6c, 6d are not shown because they overlap with the metallic wires 6a, 6b. Driving coil blocks 10a, 10c are spaced from the magnet 3a so as to face one side of the pole faces of the magnet 3a. Similarly, driving coil blocks 10b, 10d are spaced from the magnet 3b so as to face one side of the pole faces of the magnet 3b. The driving coil blocks 10a to 10d are provided with driving coils 8a to 8d for focusing and driving coils 9a to 9d for tracking and planted on the stationary base 5. The driving coils 8a to 8d and 9a to 9d are wound around yokes 7a to 7d (not shown) made of a magnetic material. Each of the driving coils 8a to 8d has a coil axis extending in the direction of the optical axis L of the objective lens 1, and each of the driving coils 9a to 9d has a coil axis extending in the direction of a disk radius r. In FIG. 4, numeral 20 indicates an imaginary line of the circumference of a disk.

With the above configuration, for the driving in the focusing direction, the driving coils 8a to 8d in the driving coil blocks 10a to 10d are supplied with electric current to produce the driving force in the same direction. Also, for the driving in the tracking direction T, the driving coils 9a to 9d are supplied with electric current to produce the driving force in the same direction. On the other hand, for the driving in the radial-tilt direction RT, electric current which is superimposed on the current to produce the driving force for focusing is applied to the driving coils 8a, 8b and the driving coils 8c, 8d so as to produce the driving force respectively in opposite directions; the driving coils 8a, 8b are on one side with respect to a tangent t to a recording track of a disk that intersects the optical axis of the objective lens 1, and the driving coils 8c, 8d are on the other side with respect to the tangent t.

However, to obtain a high-density recording/reproducing apparatus for optical disks, information is recorded and reproduced by focusing light on a smaller spot using an objective lens having a high numerical aperture. In this case, since the extent of aberration caused by a tilt, which is the inclination of the optical axis of an objective lens with respect to a disk surface, increases in proportion to the cube of the numerical aperture, higher accuracy is necessary for positioning the angle of the optical axis of an objective lens with respect to a disk.

Furthermore, besides the high density, advances in high speed and miniaturization of a recording/reproducing apparatus generate the demand for an objective lens driving apparatus with an improved capacity to follow the recording tracks of a disk. In particular, it is essential for an objective lens driving apparatus to have a light, small, and powerful driving mechanism that enables high-speed operation.

However, in the conventional objective lens driving apparatus according to JP 9-22537 A, the driving coil block used in a conventional two-axis objective lens driving apparatus is divided into two parts in the radial direction at a tangent t to have the function of correcting a tilt, which is useful for a high-density recording/reproducing apparatus. Therefore, the effective magnetic flux and coil length are reduced, thus lowering the driving sensitivity of the objective lens driving apparatus. In addition, only one side of the pole faces of the magnets 3a, 3b and one side of the driving coil blocks 10a to 10d are used for producing the driving force, so that the efficiency of driving relative to the weight of a movable body becomes poor.

Furthermore, the driving coils 8a, 8c and the driving coils 8b, 8d for focusing as well as tilting, which are divided into two parts by a tangent t that intersects the optical axis of the objective lens, are adjacent to each other, respectively. Therefore, the distance between the point at which the driving force produced by each of the divided driving coils acts and the axis of rotation for tilting is small, so that the radius of curvature relative to said axis is reduced. This makes it difficult to produce a large rotation moment as the driving force for tilting.

Furthermore, using four driving coil blocks results in an increase in the cost. In addition, it is hard to handle the wire ends of the driving coils for focusing and tracking that are wound in the four driving coil blocks, and thus the efficiency of assembly is reduced.

### SUMMARY OF THE INVENTION

Therefore, with the foregoing in mind, it is an object of the present invention to provide an objective lens driving apparatus that has the function of correcting a tilt, significantly enhances the driving sensitivity to all the three-axis driving of focusing, tracking, and tilting, and enables miniaturization and reduction in thickness.

To solve the above-mentioned problems of the conventional objective lens driving apparatus, the present invention is directed toward a three-axis objective lens driving apparatus of moving-magnet type with conventional four wire suspensions, in particular, the objective lens driving apparatus having the configuration in which a magnet and a driving coil block are arranged in the following manner.

A driving means for driving an objective lens in three axes includes a pair of driving coil blocks, each of which is provided with a driving coil for focusing and a driving coil for tracking that are wound around a yoke made of a magnetic material. The driving coil for focusing has a coil axis extending in the direction of the optical axis of the objective lens. The driving coil for tracking has a coil axis extending in the radial direction of a disk. A pair of driving coil blocks are planted on a stationary base so as to be symmetrical with respect to the objective lens in the radial direction of the disk. The direction of magnetization of magnets fixed to a lens holder corresponds to the direction of a tangent to a recording track of the disk. The magnets are placed at a predetermined distance from the driving coil block so that the driving coil block is sandwiched therebetween and the pole faces of the same sign of the magnets are opposite to both sides of each of the driving coil blocks in the direction of a tangent to a recording track of the disk. The driving coils for focusing provided in a pair of driving coil blocks are supplied with electric current to produce the driving force respectively in opposite directions, so that the driving of rotation around the axis extending in the direction of a tangent to a recording track of the disk, i.e. the driving in the radial-tilt direction, is performed.

The present invention can improve the driving sensitivity because the magnets are on both sides of each of the driving coil blocks. For example, when the driving in the radial-tilt direction is performed, both sides of the driving coil for focusing provided in the driving coil block are used for the radial-tilt driving, so that the effective part of the coil is two times that of the conventional one, which allows the driving sensitivity to be improved significantly. Furthermore, since the driving coil blocks are placed at the positions apart from the axis of rotation for tilting, a large rotation moment as the driving force for tilting can be produced.

In an objective lens driving apparatus of the present invention, it is preferable that four magnets are used, and that the center of gravity of the four magnets as a whole and the center of gravity of the movable body coincide. This can eliminate unnecessary resonance and provide a favorable frequency characteristic.

In an objective lens driving apparatus of the present invention, it is preferable that the lens holder, the magnets, a supporting member, and the stationary base are formed into a single component. This can reduce the number of parts and assembly operations, thereby lowering the cost.

Furthermore, it is preferable that the magnets are placed symmetrically so as to have different magnetic pole orientations with respect to an axis that extends in the direction of a tangent to a recording track of the disk and goes through the center of the objective lens. This can improve the driving sensitivity.

These and other advantages of the present invention will become apparent to those skilled in the art upon reading and understanding the following detailed description with reference to the accompanying figures.

### BRIEF DESCRIPTION OF THE DRAWINGS

FIG. 1A is a schematic plan view showing an objective lens driving apparatus of Embodiment 1 of the present invention, and FIG. 1B is a side view showing the same.

FIG. 2 is a schematic plan view showing a main part of an objective lens driving apparatus of Embodiment 2 of the present invention.

FIG. 3A is a schematic plan view showing a main part of an objective lens driving apparatus of Embodiment 3 of the present invention, and FIG. 3B is a cross-sectional side view showing the same.

FIG. 4 is a schematic plan view showing a conventional objective lens driving apparatus.

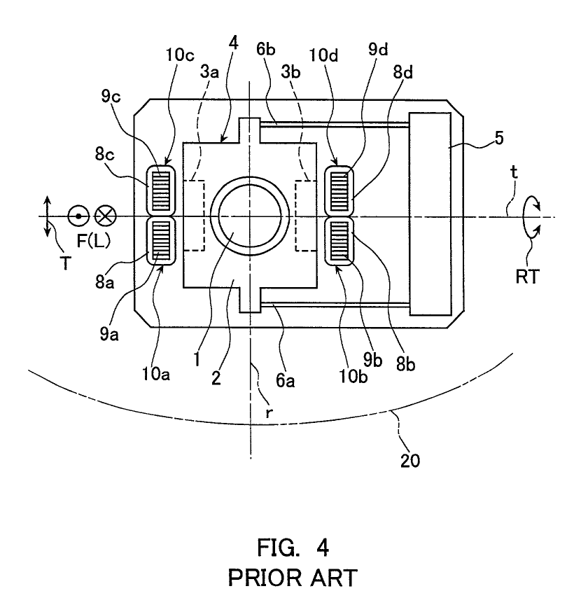

### DESCRIPTION OF THE PREFERRED EMBODIMENTS

Embodiment 1

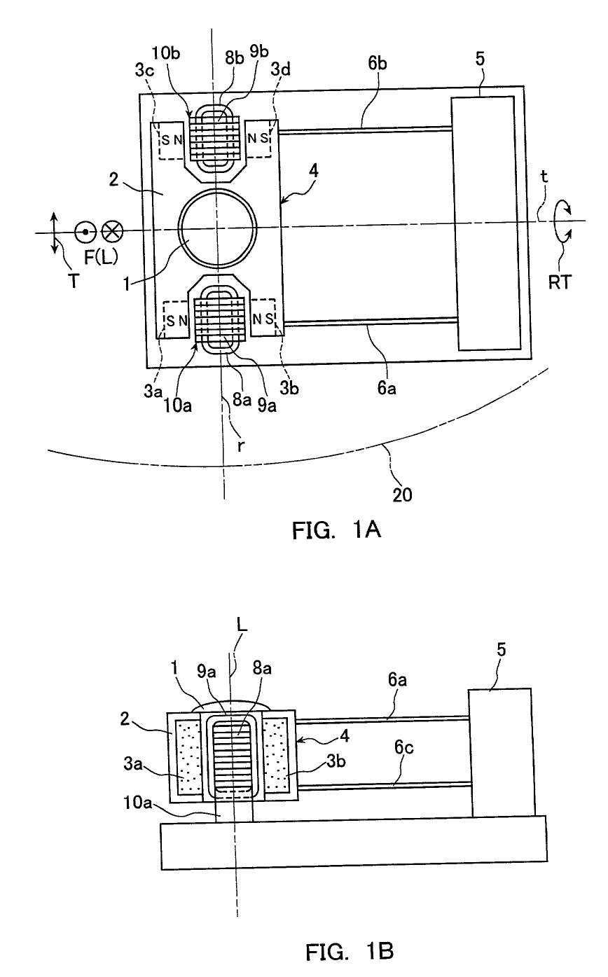

FIG. 1A is a schematic plan view showing an objective lens driving apparatus of Embodiment 1 of the present invention, and FIG. 1B is a side view showing the same. Herein, the identical elements to those in the conventional objective lens driving apparatus are denoted by the same reference numerals.

The configuration of an objective lens driving apparatus of this embodiment will be described. A movable body 4 includes an objective lens 1, a lens holder 2 for holding the objective lens 1, and magnets 3a to 3d fixed to the lens holder 2. The movable body 4 is supported elastically by a stationary base 5 with four metallic wires (supporting members) 6a to 6d that are parallel to each other with one end fixed to the movable body 4 and the other end fixed to the stationary base 5. In FIG. 1A, the metallic wires 6c, 6d are not shown because they overlap with the metallic wires 6a, 6b; in FIG. 1B, the metallic wires 6b, 6d are not shown because they overlap with the metallic wires 6a, 6c. A pair of driving coil blocks 10a, 10b are planted on the stationary base 5 so as to be symmetrical with respect to the center of the objective lens 1 in the direction of a disk radius r. The driving coil blocks 10a, 10b are provided with driving coils 8a, 8b for focusing and driving coils 9a, 9b for tracking that are wound around yokes 7a, 7b (not shown) made of a magnetic material. Each of the driving coils 8a, 8b has a coil axis extending in the direction of the optical axis L of the objective lens 1, and each of the driving coils 9a, 9b has a coil axis extending in the direction of a disk radius r. The direction of the magnetization of all the magnets 3a, 3b, 3c, and 3d fixed to the movable body 4 corresponds to the direction of a tangent t to a recording track of a disk. The magnets 3a and 3b are placed at a predetermined distance from the driving coil block 10a so that the driving coil block lOa is sandwiched therebetween and the north pole faces of the magnets 3a, 3b are opposite to both sides of the driving coil block 10a in the direction of a tangent t to a recording track of a disk. Similarly, the magnets 3c and 3d are placed at a predetermined distance from the driving coil block 10b so that the driving coil block 10b is sandwiched therebetween and the north pole faces of the magnets 3c, 3d are opposite to both sides of the driving coil block 10b in the direction of a tangent t to a recording track of a disk. In FIG. 1A, numeral 20 indicates an imaginary line of the circumference of a disk. There is no particular limitation to a disk to be used in the present invention, and well-known disks on which concentric or spiral recording tracks are formed can be used. Furthermore, the disk radius r is the radius that contains a point at which the optical axis of the objective lens 1 passes through a disk, whereas the tangent t to a recording track of a disk is the tangent to the recording track at that point.

A light path between the elements for emitting and receiving light (not shown) and the objective lens 1 can be ensured in a conventional manner, forming a through hole in the region of the stationary base 5 opposed to the objective lens 1 and providing a reflecting mirror on the side opposed to the objective lens 1 with respect to the stationary base 5. Alternatively, like Embodiment 3 to be described later, a prism can be provided between the objective lens 1 and the stationary base 5.

Hereinafter, the operation of the objective lens driving apparatus thus formed will be described. For the driving in the focusing direction (the direction of the optical axis L), each of the driving coils 8a, 8b in the two driving coil blocks 10a, 10b is supplied with electric current to produce the driving force in the same direction. Also, for the driving in the tracking direction T, each of the driving coils 9a, 9b is supplied with electric current to produce the driving force in the same direction. On the other hand, for the driving in the radial-tilt direction RT, electric current which is superimposed on the current to produce the driving force for focusing is applied to each of the driving coils 8a, 8b in the two driving coil blocks 10a, 10b so as to produce the driving force respectively in opposite directions.

In Embodiment 1, since the magnets 3a, 3b and the magnets 3c, 3d are on both sides of the driving coil blocks 10a, 10b, respectively, either side of the driving coils 8a, 8b or the driving coils 9a, 9b can be used for the driving in all the directions of focusing, tracking, and tilting. Thus, the driving sensitivity can be improved. For example, when the driving in the radial-tilt direction is performed, both sides of each of the driving coils 8a, 8b in the tangent t direction are used, the driving coils 8a, 8b being wound in the driving coil blocks 10a, 10b, respectively. Thus, the effective part of the coil that produces a driving torque in the radial-tilt direction RT is two times that of the conventional one, which allows the driving sensitivity to be improved significantly. Furthermore, the driving coil blocks 10a, 10b are spaced apart in the radius r direction on both sides of the objective lens 1, so that the point at which the driving force for tilting acts is away from the axis of rotation for tilting. This makes it possible to produce a large rotation moment as the driving force for tilting.

Furthermore, using two driving coil blocks 10a, 10b allows for reduction in parts and steps for handling the wire ends of the coils.

In Embodiment 1, the position of the center of gravity of the four magnets 3a to 3d as a whole and the position of the center of gravity of the movable body 4 may coincide, which can prevent unnecessary resonance from occurring and provide a favorable frequency characteristic.

In Embodiment 1, the lens holder 2, the four magnets 3a to 3d, the four metallic wires 6a to 6d, and the stationary base 5 may be formed into a single component by insert-molding or the like, so that a three-axis objective lens driving apparatus that reduces assembly operations as well as assembly variations and is suitable for mass production can be provided.

Embodiment 2

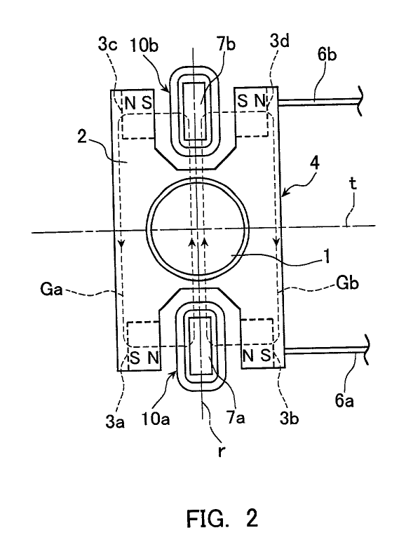

FIG. 2 is a schematic plan view showing the configuration of a movable body 4 and its vicinities of an objective lens driving apparatus of Embodiment 2 of the present invention. Herein, the identical elements to those in Embodiment 1 are denoted by the same reference numerals, and the description will be omitted.

In Embodiment 2, four magnets 3a to 3d fixed to a lens holder 2 are placed so that the magnetic poles of the two magnets 3c, 3d on one side with respect to an axis that extends in the direction of a tangent t to a recording track and goes through the center of an objective lens 1 are different from those of the two magnets 3a, 3b on the other side with respect to the axis, respectively. In other words, unlike Embodiment 1, the magnets 3c, 3d are placed with the south pole faces opposed to the driving coil block 10b. As a result, a magnetic path Ga is formed on one side with respect to a disk radius r by the magnets 3a, 3c and yokes 7a, 7b provided in the center of the driving coil blocks 10a, 10b. Similarly, a magnetic path Gb is formed on the other side with respect to the disk radius r by the magnets 3b, 3d and the yokes 7a, 7b provided in the center of the driving coil blocks 10a, 10b. In addition, the directions of the magnetic paths Ga and Gb on the radius r through the center of the objective lens 1 are the same. In this case, it is obvious that the direction of the current to produce the driving force in the focusing, tracking, and radial-tilt directions is different from that in Embodiment 1.

Therefore, in Embodiment 2, the amount of effective magnetic flux can be increased by forming the magnetic paths Ga and Gb, which results in further enhancement of the driving sensitivity.

Embodiment 3

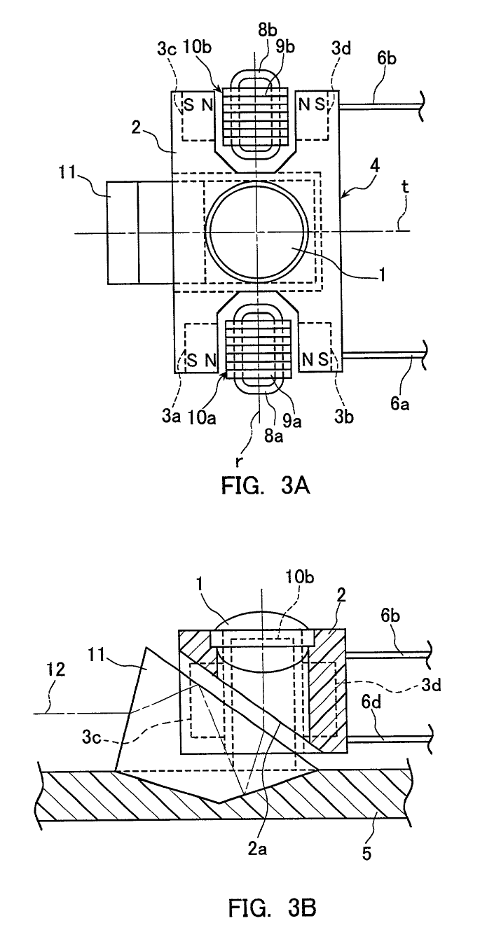

FIG. 3A is a schematic plan view showing a main part of an objective lens driving apparatus of Embodiment 3 of the present invention, and FIG. 3B is a cross-sectional side view taken on the optical axis of an objective lens. Herein, the identical elements to those in Embodiment 1 are denoted by the same reference numerals, and the description will be omitted.

As described above, in an objective lens driving apparatus of the present invention, magnets 3a to 3d and driving coil blocks 10a, 10b that produce the driving force are placed symmetrically with respect to an objective lens 1 in the direction of a disk radius r. Thus, a space can be provided in the area between the objective lens 1 and a stationary base 5 and the area extending from said area in the tangent t direction without causing interference with the components. Therefore, as shown in FIGS. 3A and 3B, a portion of the lower face of the lens holder 2 between the magnets 3a and 3c is cut away, and a beam-raising prism 11 is placed on the stationary base 5. The inclination angle of the bottom face 2a of the cut-away portion of the lens holder 2 is substantially equal to that of the top face of the beam-raising prism 11, so that the beam-raising prism 11 can be placed under the objective lens 1 not in contact with the lens holder 2. Thus, the total thickness of an optical pickup can be reduced as compared with the conventional configuration in which a reflecting mirror is provided on the lower face of the stationary base 5. In FIG. 3B, numeral 12 indicates a principal ray of the light beam for recording/reproducing information on a disk.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. An objective lens driving apparatus for three-axis driving comprising:
a movable body including an objective lens for irradiating a disk having concentric or spiral recording tracks with a laser beam, a lens holder for holding the objective lens, and magnets fixed to the lens holder;
a stationary base;
a supporting member for elastically supporting the movable body with one end fixed to the movable body and the other end fixed to the stationary base; and
a driving means for moving the movable body in a direction of an optical axis of the objective lens and in a radial direction of the disk and for turning the movable body around an axis extending in a direction of a tangent to a recording track of the disk,
wherein the driving means includes a pair of driving coil blocks, each of which is provided with a driving coil for focusing and a driving coil for tracking that are wound around a yoke made of a magnetic material, the driving coil for focusing has a coil axis extending in the direction of the optical axis of the objective lens and the driving coil for tracking has a coil axis extending in the radial direction of the disk, and the pair of driving coil blocks are fixed to the stationary base so as to be symmetrical with respect to the objective lens in the radial direction of the disk,
a direction of magnetization of the magnets fixed to the lens holder corresponds to the direction of a tangent to a recording track of the disk, and the magnets are placed at a predetermined distance from the driving coil block so that the driving coil block is sandwiched therebetween and pole faces of the same sign of the magnets are opposite to both sides of each of the driving coil blocks in the direction of a tangent to a recording track of the disk, and
the driving coils for focusing provided in the pair of driving coil blocks are supplied with electric current to produce a driving force respectively in opposite directions, so that a driving force for rotation around an axis extending in the direction of a tangent to a recording track of the disk is provided.

2. The objective lens driving apparatus according to claim 1, wherein the number of the magnets is four, and a position of the center of gravity of the four magnets as a whole and a position of the center of gravity of the movable body coincide.

3. The objective lens driving apparatus according to claim 1, wherein the lens holder, the magnets, the supporting member, and the stationary base are formed into a single component.

4. The objective lens driving apparatus according to claim 2, wherein the lens holder, the magnets, the supporting member, and the stationary base are formed into a single component.

5. The objective lens driving apparatus according to claim 1, wherein the magnets are placed symmetrically so as to have different magnetic pole orientations with respect to an axis that extends in the direction of a tangent to a recording track of the disk and goes through a center of the objective lens.

6. The objective lens driving apparatus according to claim 2, wherein the magnets are placed symmetrically so as to have different magnetic pole orientations with respect to an axis that extends in the direction of a tangent to a recording track of the disk and goes through a center of the objective lens.

7. The objective lens driving apparatus according to claim 3, wherein the magnets are placed symmetrically so as to have different magnetic pole orientations with respect to an axis that extends in the direction of a tangent to a recording track of the disk and goes through a center of the objective lens.

8. The objective lens driving apparatus according to claim 4, wherein the magnets are placed symmetrically so as to have different magnetic pole orientations with respect to an axis that extends in the direction of a tangent to a recording track of the disk and goes through a center of the objective lens.
